(19) United States
(12) Patent Application Publication
(10) Pub. No.: US 2009/0037475 A1
(43) Pub. Date: Feb. 5, 2009

(54) Image Processing Device, Image Processing Method, and Image Processing Program

(75) Inventors: Takayoshi KOJIMA, Azumino-shi (JP); Toshifumi SAKAI, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/182,927

(22) Filed: Jul. 30, 2008

(30) Foreign Application Priority Data
Aug. 1, 2007 (JP) 2007-200819

(51) Int. Cl. G06F 17/30

(52) U.S. Cl. 707/104.1; 707/E17.009

(57) ABSTRACT

An image processing device includes a data reading unit which can read data from a storage medium storing image data group including RAW data and developed data obtained by developing the RAW data, a matching information storage unit which stores matching information including information associated with editing contents with which the RAW data included in the image data group undergoes image editing processing and information associated with editing contents with which the developed data included in the image data group undergoes image editing processing, an editing instruction acquiring unit which acquires the editing contents from editing data which is inputted by user's manipulation, is associated with the image data group, and includes predetermined editing contents with which any data included in the image data group undergoes image editing processing, an object setting unit which sets either the RAW data or the developed data included in the image data group as processing object data which undergoes image editing processing with the editing contents on the basis of the acquired editing contents and the matching information, and a processing performing unit which controls the data reading unit to read the set processing object data and performs image editing processing with respect to the read processing object data with the acquired editing contents.

### BACKGROUND

1. Technical Field

The present invention relates to an image processing device, an image processing method, and an image processing program.

2. Related Art

JP-A-2003-317078 discloses an image processing device which produces an image for display (referred to as display image) using an original image while keeping the original image, and stores contents (processing information) of image edition conducted by a user with respect to the display image along with the original image as a file.

The image processing device disclosed in JP-A-2003-317078 applies contents of edition (editing contents) to the display image produced for the purpose of display regardless of the editing contents. However, some of the editing contents are suitable for edition of the original image but the other of the editing contents is suitable for edition of the display image. Accordingly, when changing an object image to be edited according to the editing contents, the image to be edited must be selected first between the original image and the display image by a user.

### SUMMARY

An advantage of some aspects of the invention is to provide an image processing device, an image processing method, and an image processing program which can apply editing contents to object data without user's intervention that a user selects an image to which the editing contents are applied among a plurality of images.

In order to accomplish the advantage of the invention, according to one aspect of the invention, there is provided an image processing device including a data reading unit which can read data out from a storage medium storing image data group including RAW data and developed data obtained by developing the RAW, a matching information storage unit which stores matching information including information associated with editing contents to be applied to the RAW data of the image data group for edition of an image and information associated with editing contents to be applied to the developed data of the image data group for edition of an image, a editing contents acquiring unit which acquires the editing contents from editing data which is inputted by user's manipulation, is associated with the image data group and which includes predetermined editing contents to be applied to any data in the image data group, an object setting unit which sets either the RAW data or the developed data in the image data group as processing object data to which the editing contents are applied on the basis of the acquired editing contents and the matching information, and a processing performing unit which controls the data reading unit so that the set processing object data is read out and applies the acquired editing contents to the read processing object data.

In the image processing device, it is preferable that the editing contents are acquired from editing data containing predetermined editing contents which are performed with respect to any data contained in the image data group matched with the image data group inputted by user's manipulation, and either the RAW data or the developed data contained in the image data group is set as processing object data to which the editing contents are applied on the basis of the acquired editing contents and the matching information. Further the data reading unit is controlled so that the set processing object data is read out and the acquired editing contents are applied to the read processing object data. In this manner, the processing object data depending on the editing contents is determined in advance, and when the editing contents are acquired by the user, either the RAW data or the developed data is selected according to the editing contents. Accordingly, without user's identification such that a user determines to which of data the editing contents are applied, it is possible to apply the editing contents to the object data. Here, examples of the predetermined editing contents include white balance adjusting processing, sensitizing processing, desensitizing processing, trimming processing, shrinkage processing, and monochromatic processing.

The image processing device can edit the editing contents contained in the editing data matched with the image data group by user's manipulation. When a user edits the editing contents, the editing data is updated or a new editing data is created according to the editing contents by an editing unit. The editing unit may apply the edited editing contents to the processing object data. With this structure, it is possible to store the editing contents edited by a user as editing data and the editing data can be applied to the RAW data or the developed data.

In the image processing device, the editing instruction acquiring unit may read the editing contents from the editing data stored in the storage medium as the editing contents inputted by the user's manipulation when the image data group including data, which is to undergo image editing processing with the predetermined editing contents, is specified by a user. With this structure, the user can apply the editing contents to the RAW data or the developed data included in the image data group without identifying each piece of data included in the image data group by specifying the image data group.

In the image processing device, after the RAW data is set as the processing object data, the object setting unit may set the RAW data as the processing object data regardless of the editing contents inputted by the user's manipulation. With this structure, if the RAW data is set as the processing object data once, the processing object data is not changed with the developed data. Accordingly, it is possible to save the time to set the developed data again as the processing object data.

In the image processing device, the matching information storage unit may store the editing contents including at least one processing of white balance adjusting processing, sensitizing processing, and desensitizing processing as the editing contents with which the RAW data included in the image data group undergoes image editing processing, and/or store the editing contents including at least one processing of trimming processing, shrinkage processing, and monochromatic processing as the editing contents with which the developed data included in the image data undergoes image editing processing. With this structure, since the white balance adjusting processing, sensitizing processing and desensitizing processing are associated with development, it is preferable that such processing is performed with respect to the RAW data. Further, since the trimming processing, the shrinkage processing, and the monochromatic processing may be performed with respect to the developed data obtained after the development processing or it is possible to rapidly perform the processing because the development is not needed.

In the image processing device, the object setting unit may set the RAW data included in the image data group as the processing object data when there are editing contents which are associated with the editing contents stored in the matching information storage unit and with which the RAW data included in the image data group undergoes image editing processing among the editing contents acquired by the editing instruction acquiring unit, and sets the developed data included in the image data group as the processing object data when there is no editing contents which are associated with the editing contents stored in the matching information storage unit and with which the RAW data included in the image data group undergoes image editing processing among the editing contents acquired by the editing instruction acquiring unit. With this structure, it is possible to surely perform the image processing with respect to the RAW data when performing the image processing with respect to the RAW data.

The image processing device may further include an outputting device which outputs the processing object data to which the editing contents is applied. It is preferable that the outputting unit be displaying means, printing means, or sending means.

According to another aspect of the invention, there is provided an image processing method of an image processing device, which is performed by means of computer software, the image processing device including a data reading unit which can read data from a storage medium storing image data group including RAW data and developed data obtained by developing the RAW data and a matching information storage unit which stores matching information which consists of information associated with editing contents with which the RAW data included in the image data group undergoes image editing processing and information associated with editing contents with which the developed data included in the image data group undergoes image editing processing, the method including acquiring editing contents from editing data which is inputted by user's manipulation, is associated with image data group, and includes predetermined editing contents with which any data included in the image data group undergoes image editing processing, setting either the RAW data or the developed data included in the image data group as processing object data, which undergoes the image editing processing with the editing contents, on the basis of the acquired editing contents and the matching information, and controlling the data reading unit to read the set processing object data and applying the acquired editing contents to the read processing object data for image edition.

In the image processing method, the editing contents is acquired from editing data which is inputted by user's manipulation, is associated with the image data group, and includes predetermined editing contents performed with respect to any data included in the image data group. Either the RAW data or the developed data included in the image data group is set as the processing object data which is to undergo image processing with the editing contents on the basis of the acquired editing contents and the matching information. The data reading unit is controlled so that the set processing object data is read out and the red processing object data undergoes image processing with the editing contents. In this manner, the processing object data is determined according to the editing contents in advance and saved in the matching information. Then, when the editing contents are acquired from the user, either the RAW data or the developed data is selected according to the editing contents for image processing. Accordingly, without user's intervention such that the user determines to which data the editing contents is applied, the editing contents is applied to the processing object data. The image processing method may further include a step of realizing any function of the image processing device according to some aspect of the invention.

According to further aspect of the invention, there is provided a program which executes each of steps of the image processing device in a single computer or a plurality of computers. The program may be recorded in a computer readable recording medium, such as hard disk, read only memory (ROM), floppy disk (FD), compact disk (CD), digital versatile disk (DVD), etc., may be transmitted from one computer to another computer via a transmission medium, for example communication network, such as Internet and local area network (LAN), or may be transmitted in any form. If the program is executed in a single computer or in a plurality of computers in distributed form, steps of the image processing method are performed. Accordingly, it is possible to obtain the same advantage as the above-mentioned image processing method.

### BRIEF DESCRIPTION OF THE DRAWINGS

The invention will be described with reference to the accompanying drawings, wherein like numbers reference like elements.

FIG. 1 is an explanatory view illustrating the overall structure of a multifunction printer 10.

FIG. 2 is an explanatory view illustrating a file stored in a memory card 42.

FIG. 3 is an explanatory view illustrating matching information stored in a read only memory (ROM) 64.

FIGS. 4A and 4B are explanatory views illustrating an image selection screen 80 and an editing screen 82 displayed on a displaying portion 52.

FIG. 5 is a flowchart showing an editing print processing routine.

### DESCRIPTION OF EXEMPLARY EMBODIMENTS

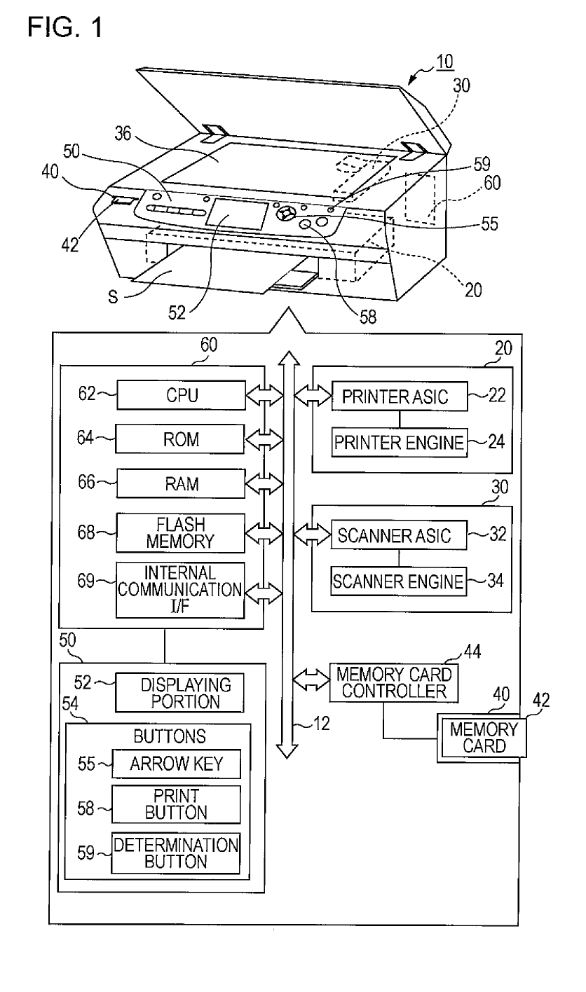

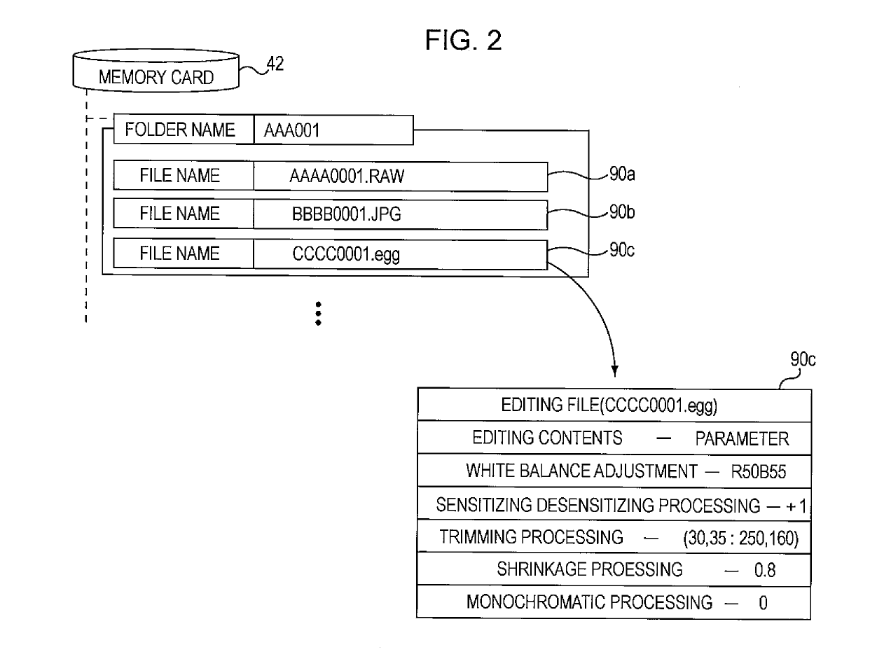

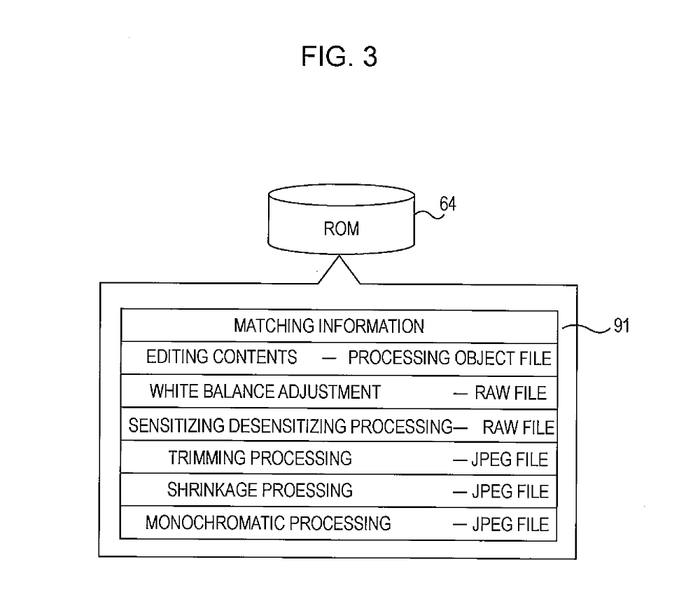

Hereinafter, embodiments of the invention will be described with reference to the accompanying drawings. FIG. 1 is a block diagram illustrating the overall structure of a multifunction printer 10 which is one embodiment of an image processing device according to the invention, FIG. 2 is an explanatory view illustrating a file stored in a memory card 42, FIG. 3 is an explanatory view illustrating correspondence stored in a read only memory (ROM) 64. As shown in FIG. 1, the multifunction printer 10 according to one embodiment of the invention includes a printer unit 20 which performs printing to recording paper S on the basis of printing job, a scanner unit 30 which reads a document disposed on a glass plate 36, a memory card controller 44 which inputs and outputs data into and from a memory card 42 inserted in a memory card slot 40, an operation panel 50 which displays various information on the displaying portion 52 or inputs user's instruction by the operation of button group 54, and a main controller 60 which controls the whole device. The multifunction printer 10 is structured such that the printer unit 20 or the scanner unit 30, the memory card controller 44, and the main controller 60 perform exchange of various control signals and data via a bus 12.

The printer unit 20 includes a printer application-specific integrated circuit (ASIC) 22 and a printer engine 24. The printer ASIC 22 is an integrated circuit for controlling the printer engine 24. When a print instruction is inputted from the main controller 60, the printer ASIC 22 controls the printer engine 24 so as to perform printing on recording paper S on the basis of image file which is an object of the print instruction. The printer engine 24 is constructed as a known ink-jet type color printer which performs printing by ejecting ink to the recording paper S from a print head. With this embodiment, the ink-jet type printer ejects ink by applying pressure to ink by means of deformation of piezoelectric elements. Alternatively, the printer may eject ink by applying pressure to ink by means of bubbles which are generated by applying heat.

The scanner unit 30 includes a scanner ASIC 32 and a scanner engine 34. The scanner ASIC 32 is an integrated circuit for controlling the scanner engine 34. When a scanning instruction is inputted from the main controller 60, the scanner ASIC 32 controls the scanner engine 34 so as to read a document disposed on a glass plate 36 as image data. The scanner engine 34 is constructed as a known image scanner and includes a known color image sensor which emits light toward the document, and splits the reflected light into red R, green G and blue B light as scan data.

The memory card controller 44 inputs and outputs data into and from the memory card 42 inserted into the memory card slot 40 disposed next to the operation panel 50. When the memory card 42 is connected to the memory card slot 40, the memory card controller 44 reads a file stored in the memory card 42 and then sends the read file to the main controller 60, or receives an instruction from the main controller 60 and then writes data into the memory card 42 on the basis of the instruction. With this embodiment, as shown in FIG. 2, the memory card 42 stores a RAW file 90a produced as a user takes a photograph of an object using a digital camera and a JPEG file 90b produced by developing the RAW file 90a. Moreover, a editing file 90c containing editing contents, with which the user performs image editing processing with respect to the RAW file 90a or the JPEG file 90b, as contents thereof is stored in the memory card 42 while it is associated with the RAW file 90a and the JPEG file 90b. Although not shown in drawings in detail, another RAW file and JPEG file produced by taking a photograph of another object and an editing file are also stored in the memory card 42.

Hereinafter, the RAW file 90a, the JPEG file 90b, and the editing file 90c will be described. The RAW file 90a is a file containing RAW data which is unprocessed data. That is, the RAW file 90a contains data produced by digitizing electric signals obtained from charges generated by light received by photographic elements, such as charge coupled devices (CCD) or CMOS of a digital camera. Another RAW file is also the same type of data. The RAW data can abundantly express tones with 8 to 16 bits for each color of R, G, and B. The RAW files exist in the uncompressed form or in the lossless compressed form so that the compressed file can be recovered to its original form. The JPEG file 90b contains JPEG data which is image data developed from the RAW data and then compressed in JPEG form and thumbnail data produced as image data when displaying a plurality of pieces of image data. As shown in FIG. 2, the editing file 90c is a file in which editing contents to be applied to at least one of the RAW data of the RAW file 90a and the JPEG data of the JPEG file 90b and editing parameters are associated. The editing file 90c stores the editing contents edited by a user, and does not store the editing contents which are not edited by a user. In greater detail, the editing contents which are not edited by a user include white balance adjusting processing for adjusting color shades of the image, sensitizing•desensitizing processing for increasing or decreasing a value of each pixel, i.e. for increasing or decreasing sensitivity of a photographic element with respect to incident light, trimming processing for trimming a portion of the image, shrinkage processing for decreasing the size of the image, and monochromatic processing for changing a color image to a monochrome image.

As shown in FIG. 2, the JPEG file is named with a file name containing a 4-digit number which is consecutive to a number contained in a file name of a previous JPEG file. The RAW file is named with a file name containing a 4-digit number like the JPEG file. These image files are stored in a folder having a folder name containing a 3-digit number which is consecutive to a number contained in a folder name which is previously produced in turns. The editing file is named with a file name containing a 4-digit number like the produced JPEG file. With this embodiment, the RAW file and the JPEG file produced on the basis of the RAW file stored in the same folder are called an image file belonging to an image file group. Further, in the case in which only the RAW file is stored in a folder or only the JPEG file is stored in a folder, the file stored in the folder is called a single image file. The editing file corresponding to the image file is also stored in the same folder. In this manner, it is possible to know whether the image file belongs to the image file group by using the number of the folder name and the number of the file name. Moreover, it is possible to specify the editing file corresponding to the image file. With this embodiment, the editing file associated with the image file belonging to the image file group is stored in the folder where the image file corresponding to the editing file is stored. However, in the case in which the image file is not associated with the editing file, the editing file may be stored in another folder or in a flash memory GB of the controller 60, which will be described later.

The operation panel 50 includes a displaying portion 52 and a button group 54. The displaying portion 52 is a liquid display device, and displays an image selecting screen for selecting an image to be printed, an editing screen for editing the editing contents, and an image data displaying screen for displaying image data to be printed. The button group 54 includes an arrow key 55 which is manipulated when selecting image data to be printed or when editing the editing contents, a print button 58 which is pressed when performing printing of the image data, a determination button 59 which is pressed when fixing the selected image as an image to be edited and printed, and a power supply button which is not shown and manipulated when turning on and off the image processing device. The button group 54 is a device allowing a user to input his or her instructions to the main controller 60 via an internal communication interface 69.

The main controller 60 is constructed as a microprocessor having a central processing unit (CPU) 62 as a core and includes the ROM 64 which stores an object information file which will be described later, a RAM 66 which temporarily stores scan data, print data, and editing contents, a flash memory 68 in which data can be electrically removed and rewritten and the data can be maintained even when the power is turned off, and an internal communication interface 69 which enables to facilitate communication with the operation panel 50. The main controller 60 receives all operation signals and detection signals from the printer unit 20, the scanner unit 30, and the memory card controller 44, and receives operation signals generated in response to the operation of the operation button group 54 of the operation panel 50. In addition, the operation panel 50 outputs a reading instruction for reading the Raw file 90a, the JPEG file 90b, and the editing file 90c from the memory card 42 and sending the read files to the main controller 60, to the memory card controller 44, a print instruction for performing printing of the image data to the printer unit 20, a reading instruction to the scanner unit 30 so that the document disposed on the glass plate 36 is read as the image data in response to the scanning instruction made by the operation of the button group 54 of the operation panel 50, or a control instruction to the displaying portion 52 of the operation panel 50.

Here, the object information file stored in the ROM 64 will be described. The object information file 91 consists of information associated with editing contents performed with respect to the RAW data contained in the RAW file belonging to the image file group and information associated with editing contents performed with respect to the JPEG data contained in the JPEG file belonging to the image file group. The object information file, as shown in FIG. 3, is stored while it is associated with information of either the RAW file or the JPEG file. In greater detail, the white balance correction and sensitizing•desensitizing processing are associated with the RAW file, and the trimming processing, the shrinkage processing, and the monochromatic processing are associated with the JPEG file.

The multifunction printer 10 structured in this manner has a function of creating image data by performing developing processing including demosaic processing, white balance adjusting processing, sensitizing•desensitizing processing, and gamma correction processing with respect to the RAW data and performing image correction processing, such as shrinkage processing, trimming processing, and monochromatic processing with respect to the RAW data and the JPEG data which is contained in the JPEG file and developed data without changing the RAW data contained in the RAW file, and storing the processing contents into the editing file. The multifunction printer 10 further has a function of analyzing contents of the editing file, and creating a new image file by applying the editing contents to the RAW file and the JPEG file. When the editing file does not exist, the CPU 62 of the main controller 60 produces a new editing file, and the editing file. In contrast, when the editing file exists, the contents of the editing file are updated.

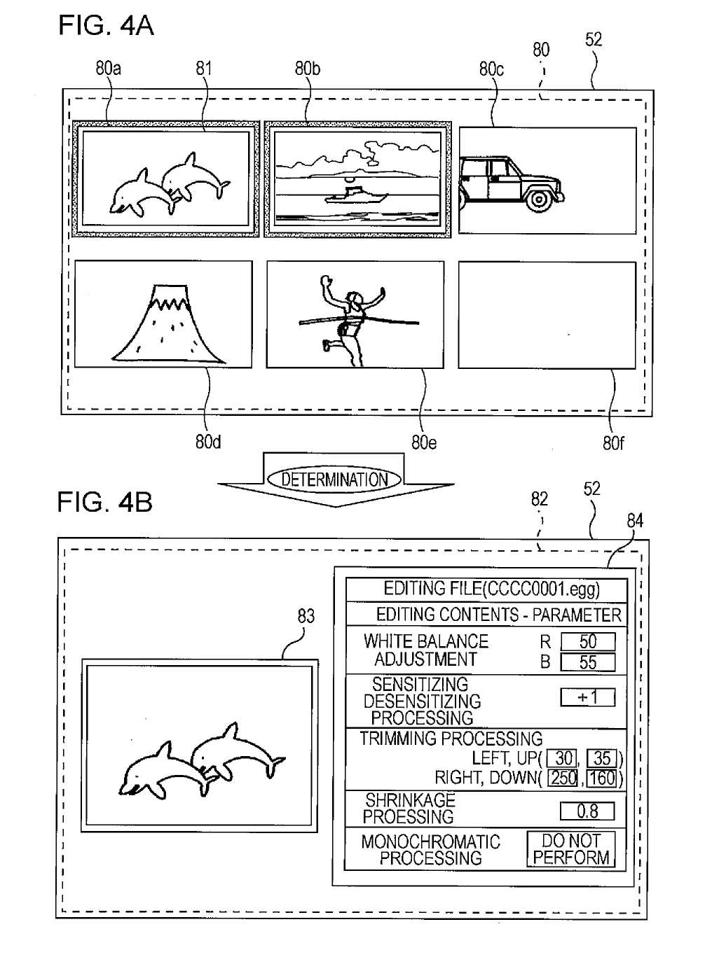

Next, operation of the ink-jet printer 10 according to the embodiment of the invention will be described. In particular, the operation performed when an image contained in the RAW data or the JPEG data corresponding to the RAW data is edited and printing of the edited image is performed in the case in which the RAW file, the JPEG file, and the editing file are stored in the memory card 42 will be described. FIGS. 4A and 4B are explanatory views illustrating an image selecting screen and an editing screen, respectively. A user inputs a displaying instruction to display the image selecting screen 80 for selecting an image to be edited and printed by manipulating the button group 54. Then, the main controller 60 outputs a control instruction to the operation panel 50 so that the image selecting screen 80 which is shown in FIG. 4A is displayed on the displaying portion 52. The operation panel which received this control instruction controls the displaying portion 52 so as to display the image selecting screen 80. Here, as shown in FIG. 4, the image selecting screen 80 arranges thumbnail images of each image file in a manner such that the images 80a, 80b, 80c, 80d, 80e, and 80f of the image file are arranged in three columns and two rows. In this state, as left and right keys of the arrow key 55 are pressed down, a cursor 81 is moved and thus a next page or a previous page is displayed. In the image selecting screen 80, the image of the image file is different from the single image file. With this embodiment, it is displayed as an image with a brim (see images 80a, 80b). Although the image file group includes the RAW file and the JPEG file, the arranged thumbnail images are contained in the JPEG file. As the user manipulates the arrow key 55, the cursor 81 is put on the image (images 80a, 80b) of the image file group among the images 80a to 80f and the images 80a and 80b are selected. In this state, if the determination button 59 is pressed down, the selected images are fixedly determined as the images to be edited and printed. After the determination, as shown in FIG. 4B, the main controller 60 outputs a control instruction to the operation panel 50 so that the editing screen 82 is displayed on the displaying portion 52 and the following editing and printing processing begins. The operation panel 50 which received the control instruction controls the displaying portion 52 so that the editing screen 82 is displayed. With this embodiment, a detailed example, in which the image 80a is an image of the image file group including the RAW file 90a and the JPEG file 90b, the image 80a is fixedly determined as the image to be edited and printed, will be described below. The editing screen 82 includes an image displaying region 83 at which image data contained in any image file of the selected file group is displayed and an editing region 84 at which editing contents to be applied to the image data by a user is displayed in an editable manner. At the image displaying region 83, the thumbnail images included in the JPEG file are displayed first, and then image data included in the RAW file or the JPEG file which is set according to the editing contents which will be described below is displayed. The editing region 84 is set in a manner such that a user can select editing location by manipulating the arrow key 55 up and down and change editing parameters by manipulating the arrow key 55 left and right.

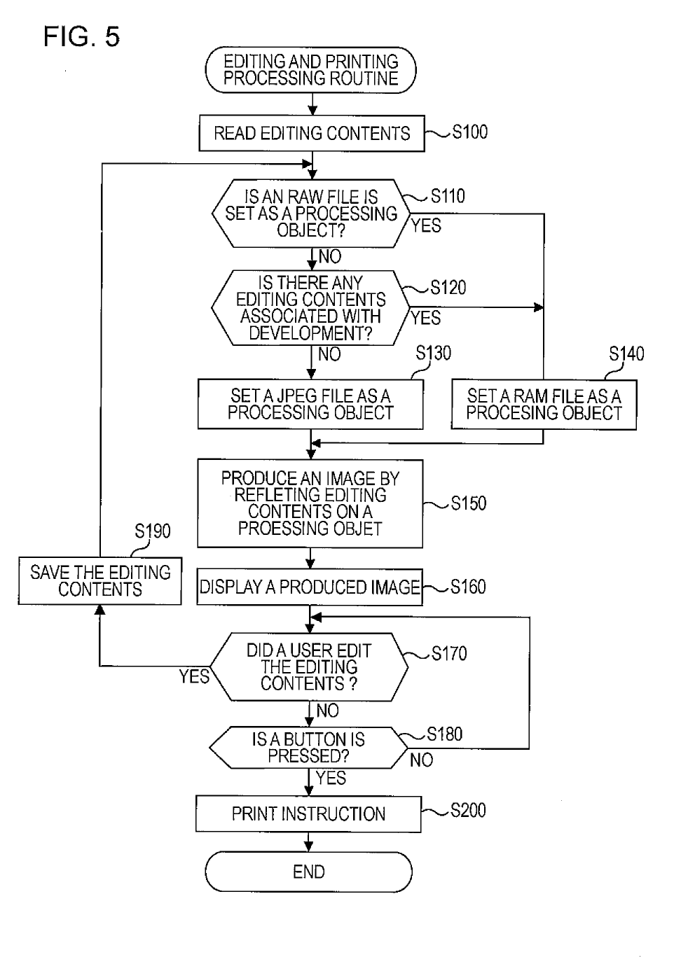

FIG. 5 is a flowchart illustrating an editing and printing processing performed by the CPU 62 of the main controller 60. This routine is stored in the ROM 64. When this routine starts, the CPU 62 outputs a read instruction to the memory card controller 44 so that the editing file matched with the selected image file group is read out (step S100). With this embodiment, the editing file 90c is read out. The memory card controller 44, which received this read instruction, reads the editing file from the memory card 42 and sends the read file to the main controller 60. Although it will be described in more detail below, it is checked whether the RAW file is set as a processing object file (step S110) even one time. With this embodiment, it is checked whether the RAW file 90a is set as the processing object file. When it is determined that the RAW file is not set as the processing object file even once, it is checked whether the read editing file contains editing contents associated with development on the basis of the relationship stored in the read editing file and the matching information file 91 (see FIG. 3) (step S120). This checking is performed based on the determination whether the editing contents in the editing file 90c are the same as the editing contents in the matching information file 91 and whether the editing contents stored in the matching information file 91 are matched with the RAW file. With this embodiment, it is determined on the basis of the editing file 90c and he matching information file 91. When the editing contents relating to development are not included, the JPEG file is set as the processing object file (step S130).

Alternatively, when the editing contents relating to the development are not contained, the RAW file is set as the processing object file (set S140). In step S110, when it is determined that the RAW file has been set as the processing image file at least one time, the RAW file is set as the processing object file (step S140). That is, when the RAW file is set as the processing object file at least one time, it means that the editing contents, in which the RAW file are used as the processing object file, was edited before, it is possible to set the RAW file as the processing object file regardless of the editing contents so that the editing contents which have been already edited before can be reflected on the subsequent editing contents. Here, the editing contents of the editing file 90c include editing contents, such as the white balance adjustment, of which a processing object is the RAW file. Since the RAW file 90a has been already set as the processing object file, the RAW file 90a is set as the processing object file. Next, after step S130 and step S140, edited image data obtained by performing development processing and image correction processing with respect to the set processing object file on the basis of the read editing contents is produced (step S150), and a control instruction is outputted to the operation panel 50 so that the produced image data is displayed (step S160). The operation panel 50 which received the control instruction controls the displaying portion 52 so that the produced image data is displayed. With this embodiment, the image data is displayed at the image displaying region 83 (see FIG. 4B). Accordingly, a user can check the image data to which editing contents included in the editing file edited by user's manipulation and stored are applied. Further, when setting the RAW file as the processing object file after the JPEG file is set as the processing object file once, the editing parameters of the JPEG file are changed to the editing parameters of the RAW file using a correspondence table which is not shown.

Next, the CPU 62 determines whether a user edited the editing contents (step S170). In greater detail, in the state in which the editing parameters of the editing region 84 are changed using the arrow key 55, the CPU 62 checks whether the determination button 59 is pressed down and the change is fixed. In the state in which the editing parameters are changed, if the change is not fixed, the CPU 62 checks whether the print button 58 is pressed down (step S180). When the print button 58 is not pressed down, the processing of step S170 is performed again. In step S170, in the state in which the editing parameters are changed, and it is determined such that the change is fixed, the CPU 62 saves the editing parameters at that time in the RAM 66 (step S190). After the editing parameters are saved in the RAM 66, the editing contents at this time may be maintained by updating the contents of the editing file, or by creating a new editing file when there is no editing file. After that, the processing after step S110 will be performed. That is, when it is determined that the editing contents saved in the RAM 66 in step S120 does not include editing contents relating to development, the JPEG file is set as the processing object file in step S130. Conversely, when it is determined such that the editing contents saved in the RAM 66 in step S120 include the editing contents relating to the development, or when it is determined such that the RAW file is set as the processing object file once in step S110, the RAW file is set as the processing object file in step S140. Further, in step S150, the editing contents stored in the RAM 66 by user's inputting operation are applied to the processing object file and thus the image data is produced. In step S160, the image data is displayed on the displaying portion 52. Accordingly, a user can check the image data to which the editing contents are applied by viewing the displaying portion 52. In addition, when a user edits further the editing contents, the CPU 62 performs the processing of step S190 and then performs the processing subsequent to step S100. When it is determined that the print button 58 is pressed down in step S180, the CPU 62 outputs a print instruction to the printer unit 20 to print the edited image data produced in step S150 (step S200), and this routine ends. The printer engine 20 which received this print instruction prints the edited image data on the recording paper S.

In the case in which the image of the single image file is fixedly determined as the image to be edited and printed by a user, the determined file is still set as the processing object file.

In this manner, either the RAW file or the JPEG file is set as the processing object file to which the editing contents are to be applied on the basis of the editing contents edited by user's manipulation and the contents of the matching information file stored in the ROM 64 in advance, and the image data to which the editing contents are applied is printed. In particular, when setting the RAW file as the processing object file, it is possible to print high quality image data obtained by applying the editing contents to the RAW data having abundant tones.

Here, the correspondence relationship between elements according the embodiment and elements according to the invention will be apparent. The multifunction printer 10 corresponds to an image processing device, the memory card controller 44 corresponds to a data reading unit, the ROM 64 corresponds to a matching information storage unit, the memory card controller 44 or the main controller 60 corresponds to an editing instruction acquiring unit, and the CPU 42 corresponds to an object setting unit and a processing performing unit. In addition, the button group 54 and the CPU 42 corresponds to an editing unit, and the JPEG data included in the JPEG file corresponds to developed data. With this embodiment, as the image processing method according to the invention will be apparent by describing operation of the multifunction printer 10.

According to the multifunction printer 10 of the embodiment, the editing contents edited by a user are acquired from the editing file matched with the image file group and the RAM 66, either the RAW file 90a or the JPEG file 90b included in the image file group is set to as the processing object file to which the editing contents are applied on the basis of the acquired editing contents and the matching information file, the set processing object file is read out, and the acquired editing contents are applied to the read processing object file. In this manner, the correspondence relationship between the editing contents and the processing object file is stored in the ROM 64 as the matching information file in advance, when the editing contents are acquired, either the RAW file 90a or the JPEG file 90b is set as the processing object file according to the editing contents. Accordingly, it is possible to apply the editing contents to the processing object file without user's intervention that a user selects the data to undergo image processing with the editing contents. In addition, a user can edit the editing contents included in the editing file matched with the image file group by manipulating the button group 54. Further, it is possible to apply the editing contents edited by a user to either the RAW file 90a or the JPEG file 90b since the CPU 62 applies the editing contents edited by a user to the processing object file. In addition, when the image file group is selected and fixedly determined by a user, the editing contents are read from the editing file stored in the memory card 42 as the editing contents inputted by the user's manipulation. Accordingly, the user can apply the editing contents to either the RAW file 90a or the JPEG file 90b included in the image file group by specifying the image file group without identifying each of the files included in the image file group. In addition, after the RAW file 90a is set as the processing object file once, the RAW file 90a is continuously set as the processing object file regardless of the editing contents. Accordingly, after the RAW file 90a is set as the processing object file once, there is no chance to reset such that the JPEG file 90b is set as the processing object file. As a result, it is possible to save the time needed for resetting. Further, since the matching information file, in which editing contents, such as the white balance adjusting processing, sensitizing processing, desensitizing processing are contained, is stored in the ROM 64 as the editing contents to be applied to the RAW file 90a belonging to the image file group, and since the white balance adjusting processing, the sensitizing processing, and the desensitizing processing relate to the development, it is preferable that the RAW file 90a undergoes such processing. Besides, since the ROM 64 stores the matching information file, in which editing contents, such as trimming processing, shrinkage processing, and monochromatic processing are included, as the editing contents to be applied to the JPEG file 90b belonging to the image file group in the ROM 64, trimming thee processing, shrinkage processing, and monochromatic processing may be applied to developed data which has undergone development processing and thus it is possible to rapidly perform the processing. Besides, when the editing contents which are the same as the editing contents stored in the matching information file 91 are matched with the RAW file, the RAW file is set as the processing object file. When the editing contents included in the matching information file 91 are not matched with the RAW file, the JPEG file is set as the processing object file. Accordingly, in the case in which the editing contents are for the RAW data, it is possible to surely perform the image processing with respect to the RAW data.

The invention is not limited to the above-mentioned embodiments, but may be embodies in various forms in the technical scope of the invention.

For example, with the above-mentioned embodiment, as the editing file stored in the matching information file, although the white balance adjusting processing, sensitizing•desensitizing processing, shrinkage processing, trimming processing, and monochromatic processing are exemplified, the editing contents are not limited thereto. For example, processing which is performed after development and is other than the above-mentioned processing and with which the RAW file is associated can be stored as the editing contents. In such a case, without user's identification about each piece of data to which the editing contents are applied, it is possible to apply the editing contents to the processing object file.

With the above-mentioned embodiment, in step S110 of the editing and printing processing shown in FIG. 5, when it is determined that the RAW file is set as the processing object file one time, the RAW file is set as the processing object file. However, processing of step S110 may not be performed. That is, it is not checked whether the RAW file is set as the processing object file one time. In even such a case, without user's identification that user picks any piece of data to undergo image processing with the editing contents, it is possible to apply the editing contents to the processing object file. Alternatively, in step S110, although the RAW file is set as the processing object file one time, in the case in which processing subsequent to previous processing is canceled or editing parameters are changed back to the original editing parameters, it may be assumed that the RAW file is not set as the processing object file even one time.

With the above-mentioned embodiment, when the RAW file 90a is set as the processing object file, the development is performed while applying the editing contents to the RAW data included in the RAW file 90a, and the image data is produced and displayed. For example, simple development which develops an image by thinning out the data is performed, and then the image data is produced and displayed while the editing contents are applied to the simply developed image. At this time, when performing printing, the development progresses while the editing contents are applied to the original RAW data and the printing is performed. In this manner, a user can quickly check the image data to which the editing contents are applied.

With the above-mentioned embodiment, the RAW file, the JPEG file, and the editing file are stored in the memory card 42. However, they may be stored in a different storage medium, such as a flash memory 68. In such a case, the image processing device is equipped with a controller which can read each of the files from the storage medium and a slot.

With the above-mentioned embodiment, the RAW file and the JPEG file stored in the memory card 42 are processing object files. However, an RAW file and a JPEG file read by the scanner unit 30 and stored in the flash memory 68 may be processing object files.

In the above-mentioned embodiment, the invention is described by exemplifying the multifunction printer 10 but may not be limited thereto. That is, any device which can perform outputting processing, such as printing, displaying, and sending with respect to the image file belonging to the image file group may be the image processing device according to the invention. That is, the invention may be applied to a picture viewer, a digital video player, a digital camera, and a camera-combined cellular phone, or may be a printing device, such as FAX with a displaying portion. In addition, although the RAW file and the JPEG file are exemplified for description, the invention may be applied to other kinds of image files, for example BMP file and TIF file. Further, the invention is described in the form of the multifunction printer 10, but the invention may be an image processing method or an image processing program.

The entire disclosure of Japanese Patent Application No. 2007-200819, filed Aug. 1, 2008 is incorporated by reference herein.

What is claimed is:

1. An image processing device comprising:
a data reading unit which can read data from a storage medium storing image data group including RAW data and developed data obtained by developing the RAW data;
a matching information storage unit which stores matching information including information associated with editing contents with which the RAW data included in the image data group undergoes image editing processing and information associated with editing contents with which the developed data included in the image data group undergoes image editing processing;
an editing instruction acquiring unit which acquires the editing contents from editing data which is inputted by user's manipulation, is associated with the image data group, and includes predetermined editing contents with which any data included in the image data group undergoes image editing processing;
an object setting unit which sets either the RAW data or the developed data included in the image data group as processing object data which undergoes image editing processing with the editing contents on the basis of the acquired editing contents and the matching information; and
a processing performing unit which controls the data reading unit to read the set processing object data and performs image editing processing with respect to the read processing object data with the acquired editing contents.

2. The image processing device according to claim 1, further comprising an editing unit which allows a user to edit the editing contents included in the editing data associated with the image data group by user's manipulation and which updates the editing contents or produces new editing contents according to the editing contents when the editing contents are edited by the user, wherein the processing performing unit is a unit for applying the edited editing contents to the processing object data.

3. The image processing device according to claim 1, wherein the editing instruction acquiring unit reads the editing contents from the editing data stored in the storage medium as the editing contents inputted by the user's manipulation when the image data group including data, which is to undergo image editing processing with the predetermined editing contents, is specified by a user.

4. The image processing device according to claim 1, wherein after the RAW data is set as the processing object data, the object setting unit sets the RAW data as the processing object data regardless of the editing contents inputted by the user's manipulation.

5. Image processing device according to claim 1, wherein the matching information storage unit stores the editing contents including at least one processing of white balance adjusting processing, sensitizing processing, and desensitizing processing as the editing contents with which the RAW data included in the image data group undergoes image editing processing, and/or stores the editing contents including at least one processing of trimming processing, shrinkage processing, and monochromatic processing as the editing contents with which the developed data included in the image data undergoes image editing processing.

6. The image processing device according to claim 1, wherein the object setting unit sets the RAW data included in the image data group as the processing object data when there is editing contents which are associated with the editing contents stored in the matching information storage unit and with which the RAW data included in the image data group undergoes image editing processing among the editing contents acquired by the editing instruction acquiring unit, and sets the developed data included in the image data group as the processing object data when there is no editing contents which are associated with the editing contents stored in the matching information storage unit and with which the RAW data included in the image data group undergoes image editing processing among the editing contents acquired by the editing instruction acquiring unit.

7. An image processing method of an image processing device, which is performed by means of computer software, the image processing device including a data reading unit which can read data from a storage medium storing image data group including RAW data and developed data obtained by developing the RAW data and a matching information storage unit which stores matching information which consists of information associated with editing contents with which the RAW data included in the image data group undergoes image editing processing and information associated with editing contents with which the developed data included in the image data group undergoes image editing processing, the method comprising:
acquiring editing contents from editing data which is inputted by user's manipulation, is associated with image data group, and includes predetermined editing contents with which any data included in the image data group undergoes image editing processing;
setting either the RAW data or the developed data included in the image data group as processing object data, which undergoes the image editing processing with the editing contents, on the basis of the acquired editing contents and the matching information; and
controlling the data reading unit to read the set processing object data and applying the acquired editing contents to the read processing object data for image edition.

8. A program executing each of steps of the image processing method according to claim 7 in one or a plurality of computers.
